(19) United States
(12) Patent Application Publication
(10) Pub. No.: US 2011/0049440 A1
(43) Pub. Date: Mar. 3, 2011

(54) METHOD OF PREPARING CONDUCTIVE NANO INK COMPOSITION

(75) Inventors: Jong-Hee Lee, Yongin-si (KR); Kyu-Nam Joo, Yongin-si (KR); Jae-Myung Kim, Yongin-si (KR); So-Ra Lee, Yongin-si (KR)

(73) Assignee: Samsung SDI Co., Ltd., Yongin-si (KR)

(21) Appl. No.: 12/829,648

(22) Filed: Jul. 2, 2010

(30) Foreign Application Priority Data
Aug. 27, 2009 (KR) 10-2009-0079762

(51) Int. Cl. H01B 1/22

(52) U.S. Cl. 252/513; 252/512; 252/514

(57) ABSTRACT

A method of preparing a conductive nano ink composition. The method includes preparing a low temperature solution by adding a portion of a metal ion solution in a mixture solvent obtained by mixing polyethylene glycol and polyvinyl alcohol, and mixing the rest of the metal ion solution to the low temperature solution.

### CLAIM OF PRIORITY

This application makes reference to, incorporates into this specification the entire contents of, and claims all benefits accruing under 35 U.S.C. §119 from an application earlier filed in the Korean Intellectual Property Office on Aug. 27, 2009, and there duly assigned Serial No. 10-2009-0079762.

### BACKGROUND OF THE INVENTION

1. Field of the Invention

One or more embodiments of the present invention relate to a method of preparing a conductive nano ink composition, and a conductive nano ink composition prepared using the method.

2. Description of the Related Art

Recently, as electronic devices have a compact size and high performance, minute wirings are needed in the electronic devices. Accordingly, an inkjet process of forming minute wirings by using metal nanoparticles as a material for conductive ink has been actively conducted.

In the inkjet process, metal nanoparticles having a particle diameter of several tens of nm are made into ink so as to be ejected on a printed circuit board. The minute wirings are formed simply by firing the ejected ink. This method is cost-effective.

In order to eject metallic conductive ink using an inkjet apparatus, nanoparticles having a size of several to several tens of nm need to have a highly stably dispersed state. According to the related art, a method of preparing a metallic conductive ink for inkjet printing includes a complicated process of preparing metallic nanoparticles using a chemical reduction method and separating, drying, and redistributing the metal nanoparticles from a solvent. In addition, during the process of separating, drying, and redistributing of the nanoparticles from the solvent, a dispersion force of the metal nanoparticles decreases and a surface energy of the metal nanoparticles increases. As a result, cohesion between the metal nanoparticles is inevitable. Consequently, when the particles are ejected on a printing circuit board, nozzle clogging may occur in an inkjet head.

### SUMMARY OF THE INVENTION

One or more embodiments of the present invention include providing an improved method of preparing a conductive nano ink composition.

One or more embodiments of the present invention include a method of simply preparing a monodispersed conductive nano ink composition.

One or more embodiments of the present invention include a conductive nano ink composition prepared using the method.

One or more embodiments of the present invention include a conductive nano ink composition that is formed by processing and redispersing the above conductive nano ink composition.

Additional aspects will be set forth in part in the description which follows and, in part, will be apparent from the description, or may be learned by practice of the presented embodiments.

According to one or more embodiments of the present invention, a method of preparing a conductive nano ink composition includes preparing a low temperature solution by adding a portion of a metal ion solution to a mixture solvent of polyethylene glycol and polyvinyl alcohol, and adding the rest of the metal ion solution to the low temperature solution.

The mixture solvent of polyethylene glycol and polyvinyl alcohol may be a high temperature mixture solvent.

The low temperature of the low temperature solution may be from about 70° C. to about 90° C.

The high temperature of the high temperature mixture solvent may be from about 90° C. to about 100° C.

The polyethylene glycol may have an average molecular weight from about 100 to about 600.

The polyvinyl alcohol may have an average molecular weight from about 10000 to about 40000.

The metal ion may be selected from the group consisting of Ag, Au, Pt, Cu, Ni, and Pd.

The metal ion solution may be prepared by dissolving a metal precursor in a lower alcohol.

The lower alcohol may be a C3-C10 alkanol.

The lower alcohol may be at least one selected from the group consisting of 2-propanol, 2-butanol, 3-butanol, 2-pentanol, and 3-pentanol.

The metal precursor may be a nitride or a chloride including at least one metal selected from the group consisting of Ag, Au, Pt, Cu, Ni, and Pd.

The metal precursor may be AgNO₃, AgCl, CH₃COOAg, PtCl₂ or AgClO₄.

According to one or more embodiments of the present invention, there is provided a to conductive nano ink composition prepared according to the above-described method.

A solid body of the conductive nano ink composition may be separated, and the separated solid body may be redispersed in a mixture solution of lower alcohol and ethylene glycol.

The conductive nano ink composition may further include a dispersant.

According to the method of preparing a conductive nano ink composition according to the embodiments of the present invention, a mixture of polyethylene glycol and alcohols is used as a long-chain solvent, and thus an intense reducing power is applied to a metal ion and solubility of a metal precursor is increased. Accordingly, monodispersed nanoparticles may be prepared within a short period of time. Also, a large amount of nucleus may be generated and ultra-fine particles may be formed at a high temperature, and crystals are gradually grown at a low temperature, thereby manufacturing metal nanoparticles having a uniform diameter distribution. In addition, since ethylene glycol and alcohols are used as ink solvents, a drying operation or a washing operation is not performed after manufacturing the metal nanoparticles. Thus, a method of manufacturing ink is simple. Also, no cohesion is generated between the metal nanoparticles, and thus ink having a long life span is obtained.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating a method of preparing a conductive nano ink composition according to an embodiment of the principles of the present invention; and

FIG. 2 illustrates a particle diameter distribution of a conductive nano ink composition according to an embodiment of the principles of the present invention.

### DETAILED DESCRIPTION OF THE INVENTION

Reference will now be made in detail to embodiments, examples of which are illustrated in the accompanying drawings, wherein like reference numerals refer to the like elements throughout. In this regard, the present embodiments, may have different forms and should not be construed as being limited to the descriptions set forth herein. Accordingly, the embodiments are merely described below, by referring to the figures, to explain aspects of the present description.

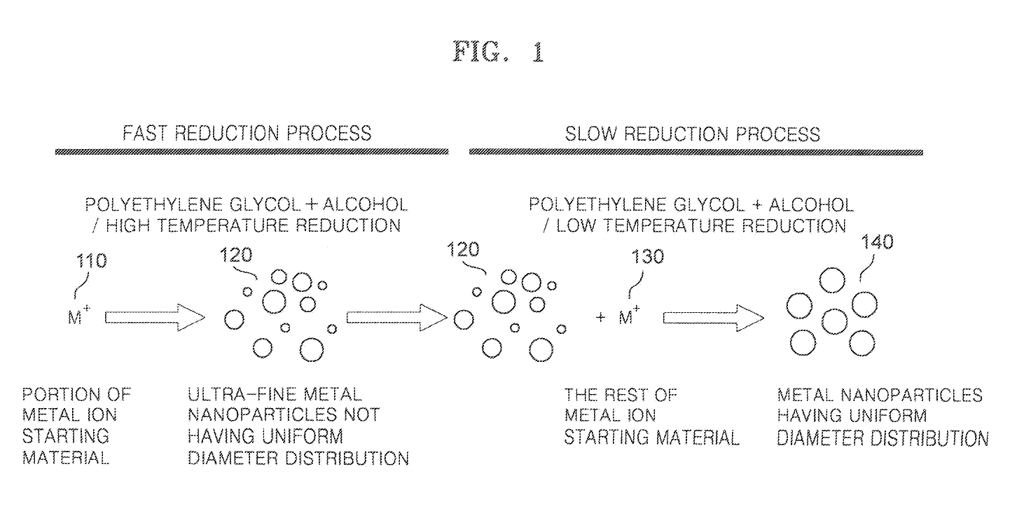

FIG. 1 is a schematic view illustrating a method of preparing a conductive nano ink composition according to an embodiment of the principles of the present invention.

The method of preparing a conductive nano ink composition according to the current embodiment of the present invention is illustrated in FIG. 1. The method includes preparing a low temperature solution 120 by adding a portion of a metal ion solution 110 to a mixture solvent of polyethylene glycol and polyvinyl alcohol. This process is represented as a fast reduction process as shown in FIG. 1. Then, the rest of the metal ion solution 130 is added to the prepared low temperature solution 120. This process is represented as a slow reduction process as shown in FIG. 1.

Initially, the mixture solvent of polyethylene glycol and polyvinyl alcohol may be a high temperature mixture solution. The high temperature of the mixture solvent of polyethylene glycol and polyvinyl alcohol may be from about 90° C. to about 100° C.

Then, the portion of the metal ion solution 110 is added and mixed in the mixture solvent of polyethylene glycol and polyvinyl alcohol, which is pre-heated to the high temperature. Then a temperature of the resultant mixture is reduced to a low temperature to form the low temperature solution 120.

The low temperature of the low temperature solution 120 may be from about 70° C. to about 90° C.

The amount of the metal ion solution is divided. A portion of the metal ion solution 110 is added to the mixture solvent of polyethylene glycol and polyvinyl alcohol and a temperature of the resultant mixture is reduced to prepare the low temperature solution 120. The rest of the metal ion solution 130 is added to the low temperature solution mixture 120. Accordingly, a conductive nano ink composition 140 in which metal nanoparticles having a diameter of several nanometers and a uniform diameter distribution is obtained.

If the high temperature and the low temperature are in the above-described ranges, respectively, metal nanoparticles having a uniform particle diameter distribution may be obtained.

According to an embodiment of the principles of the present invention, the polyethylene glycol is used as a solvent, a reducer, and an auxiliary particle growth inhibitor. The polyethylene glycol may have an average molecular weight of 100 through 600.

The polyethylene glycol may have an average molecular weight of 100 or greater, in order to enhance the hydrogen bonding force of polyethylene glycol regarding a metal ion. Thus, a reducing power of the polyethylene glycol with respect to the metal ion is increased, so that generation of a large amount of nucleus is induced. Additionally, the polyethylene glycol has a sufficient chain length for stabilizing minute particles via an ether group.

When the average molecular weight of the polyethylene glycol is more than 600, viscosity of the polyethylene glycol is too large even when a solvent is heated at 100° C. or higher, and thus fluidity of the polyethylene glycol is decreased and the growth and uniformity of particles may be affected. As a result, a dissolution power of the polyethylene glycol regarding a solute may decrease.

According to an embodiment of the principles of the present invention, the polyethylene glycol may have an average molecular weight of 200 to 300.

According to an embodiment of the principles of the present invention, the polyvinyl alcohol, which is a particle growth inhibitor, may have an average molecular weight of 10000 through 40000. When the average molecular weight of the polyvinyl alcohol is in the above range, the growth of particles is effectively inhibited.

According to an embodiment of the principles of the present invention, the metal ion may be at least one selected from the group consisting of Ag, Au, Pt, Cu, Ni, and Pd. The metal ion solution may be prepared by dissolving a metal precursor in a lower alcohol.

The lower alcohol is used in order to apply solubility to the metal precursor and the particle growth inhibitor, and to apply fluidity of the solution mixture during synthesis. According to an embodiment of the principles of the present invention, the lower alcohol may be a C3-C10 alkanol, for example, 2-propanol, 2-butanol, 3-butanol, 2-pentanol, 3-pentanol, or a combination of these.

According to an embodiment of the principles of the present invention, in order to induce generation of a large amount of nucleus, the reaction is performed at a temperature from about 90° C. to about 100° C. in an initial stage. If a carbon number of the lower alcohol is less than 3, a boiling point is too low such that the lower alcohol may become volatile, which makes it difficult to use. On the other hand, if the carbon number of the lower alcohol is greater than 10, solubility of the lower alcohol regarding the metal precursor is low.

According to an embodiment of the principles of the present invention, the metal precursor may be a nitride or a chloride including at least one metal selected from the group consisting of Ag, Au, Pt, Cu, Ni, and Pd. For example, the metal precursor may be AgNO₃, AgCl, CH₃COOAg, PtCl₂, or AgClO₄.

Referring to FIG. 1, in a fast reduction process, a portion of the metal ion solution 110, which is dissolved in the lower alcohol, is added to the preheated mixture solvent of polyethylene glycol and polyvinyl alcohol. Thus, a large amount of nucleus is generated, and ultra-fine particles not having a uniform diameter distribution due to a particle growth prevention effect of polyvinyl alcohol, which is a particle growth inhibitor, are formed. The temperature of the resultant mixture is reduced, to form a low temperature solution 120.

After the fast reduction process, the above-described slow reduction process, in which the rest of the metal ion solution 130 is added to the low temperature solution 120, is performed, thereby generating nucleus a second time. As a result, second particles are uniformly absorbed into previously formed ultra-fine particles and are grown to monodispersed nanoparticles having a uniform diameter distribution.

According to an embodiment of the principles of the present invention, the conductive nano ink composition prepared according to the method of the embodiments of the present invention may include 250 through 300 parts by weight of polyethylene glycol, 150 through 190 parts by weight of polyvinyl alcohol, and 250 through 300 parts by weight of lower alcohol based on 100 parts by weight of metal ions.

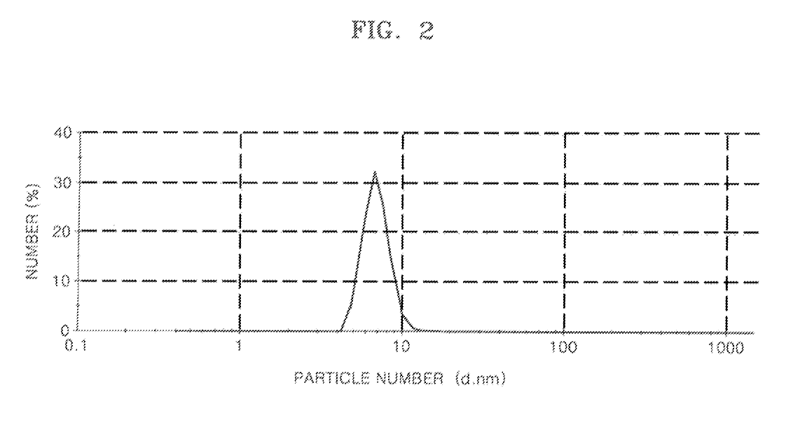

FIG. 2 illustrates a particle diameter distribution of a conductive nano ink composition according to an embodiment of the present invention.

Referring to FIG. 2, the conductive nano ink composition has a uniform particle diameter distribution.

According to an embodiment of the principles of the present invention, a solid body is separated from a conductive nano ink composition. The separated solid body is dispersed again in a mixture solution of lower alcohol and ethylene glycol to prepare a redispersed conductive nano ink composition. The redispersed conductive nano ink composition may further include a dispersant.

According to an embodiment of the principles of the present invention, the mixture solution of lower alcohol and ethylene glycol is prepared by mixing ethylene glycol in the above-described lower alcohol in a ratio of 6:4.

According to an embodiment of the principles of the present invention, the redispersed conductive nano ink composition may include 200 through 230 parts by weight of ethylene glycol, 100 through 130 parts by weight of lower alcohol, and 7 through 15 parts by weight of polyvinyl alcohol based on 100 parts by weight of metal ions.

The separated nanoparticles have a dispersion stability for several months in the mixture solvent. However, in order to provide a long-term dispersion stability, the nanoparticles may further include one dispersant selected from the group consisting of polyvinyl alcohol, BYK-108 (Manufacturer: BYK Additive & Instruments), and BYK-192 (Manufacturer: BYK Additive & Instruments).

By using the conductive nano ink composition prepared using the method of the embodiment of the present invention, a wiring having a line width in the range of about 20 to about 50 μm and a thickness less than 500 nm may be formed.

Hereinafter, examples of the conductive nano ink composition according to the embodiment of the present invention will be described; however, the embodiment of the present invention is not limited thereto.

### EXAMPLES

### Example 1

47 parts by weight of polyvinyl alcohol having a molecular weight of 30,000 was dissolved in 75 parts by weight of polyethylene glycol having an average molecular weight of 200 and was pre-heated to 100° C. 43 parts by weight of silver nitrate was dissolved as a metal ion precursor in 75 parts by weight of 2-propanol to prepare a metal ion starting solution. The prepared metal ion starting solution is 118 parts by weight, 70 parts by weight of the metal ion starting solution was added to the preheated solution of polyvinyl alcohol and polyethylene glycol, was mixed for 10 minutes, and a temperature of the resultant solution was reduced to 80° C.

The rest of the metal ion starting solution, which is 48 parts by weight, was added to the 80° C. solution in which metal nanoparticles are formed, and was mixed for 30 minutes, thereby preparing nano-sized silver particles.

The obtained silver nanoparticles have an average particle diameter of 5 nm. An analysis thereof using a particle size analyzer is shown in FIG. 2.

Solid-liquid separation was performed to obtain 15 parts by weight of silver nanoparticles using the above-described method. Then the 15 parts by weight of silver nanoparticles were dispersed again in a mixture solvent of 30 parts by weight of ethylene glycol and 20 parts by weight of 2-propanol, and 0.45 parts by weight of BYK-108 (Manufacturer: BYK Additive & Instruments) was added thereto, thereby preparing an inkjet conductive silver nano ink.

### Example 2

55.9 parts by weight of polyvinyl alcohol having a molecular weight of 10000 was dissolved in 75 parts by weight of polyethylene glycol having an average molecular weight of 400 and was preheated to 100° C. 43 parts by weight of platinum chloride (PtCl₂) was dissolved as a metal ion precursor in 75 parts by weight of 2-pentanol as a metal ionic precursor to prepare a metal ion starting solution. The metal ion starting solution in 70 parts by weight was added to the preheated solution of polyvinyl alcohol and polyethylene glycol, and was mixed for 10 minutes and a temperature thereof was reduced to 80° C.

The rest of the metal ion starting solution was added to the 80° C. solution in which metal nanoparticles are formed, and was mixed for 30 minutes to prepare nano-sized platinum it particles.

The obtained platinum nanoparticles have an average particle diameter of 7 nm.

It should be understood that the exemplary embodiments described therein should be considered in a descriptive sense only and not for purposes of limitation. Descriptions of is features or aspects within each embodiment should typically be considered as available for other similar features or aspects in other embodiments.

What is claimed is:

1. A method of preparing a conductive nano ink composition, the method comprising:
preparing a low temperature solution by adding a portion of a metal ion solution to a mixture solvent of polyethylene glycol and polyvinyl alcohol; and
adding the rest of the metal ion solution to the prepared low temperature solution.

2. The method of claim 1, wherein the mixture solvent of polyethylene glycol and polyvinyl alcohol is a high temperature mixture solvent.

3. The method of claim 2, wherein the high temperature of the high temperature mixture solvent is from about 90° C. to about 100° C.

4. The method of claim 1, wherein the low temperature of the low temperature solution is from about 70° C. to about 90° C.

5. The method of claim 1, wherein the polyethylene glycol has an average molecular weight from about 100 to about 600.

6. The method of claim 1, wherein the polyvinyl alcohol has an average molecular weight from about 10000 to about 40000.

7. The method of claim 1, wherein the metal ion is selected from the group consisting of Ag, Au, Pt, Cu, Ni, and Pd.

8. The method of claim 1, wherein the metal ion solution is prepared by dissolving a metal precursor in a lower alcohol.

9. The method of claim 8, wherein the lower alcohol is a C3-C10 alkanol.

10. The method of claim 8, wherein the lower alcohol is at least one selected from the group consisting of 2-propanol, 2-butanol, 3-butanol, 2-pentanol, and 3-pentanol.

11. The method of claim 8, wherein the metal precursor is one of a nitride and a chloride, and the metal precursor comprising at least one metal selected from the group consisting of Ag, Au, Pt, Cu, Ni, and Pd.

12. The method of claim 8, wherein the metal precursor comprising at least one selected from the group consisting of AgNO₃, AgCl, CH₃COOAg, PtCl₂ and AgClO₄.

13. A conductive nano ink composition prepared according to the method of claim 1.

14. A conductive nano ink composition prepared according to the method of claim 2.

15. A conductive nano ink composition prepared according to the method of claim 3.

16. A conductive nano ink composition prepared according to the method of claim 4.

17. A conductive nano ink composition prepared according to the method of claim 5.

18. A conductive nano ink composition prepared according to the method of claim 6.

19. A conductive nano ink composition prepared according to the method of claim 7.

20. A conductive nano ink composition prepared according to the method of claim 8.

21. A conductive nano ink composition prepared according to the method of claim 9.

22. A conductive nano ink composition prepared according to the method of claim 10.

23. A conductive nano ink composition prepared according to the method of claim 11.

24. A conductive nano ink composition prepared according to the method of claim 12.

25. The conductive nano ink composition of claim 13, wherein a solid body of the conductive nano ink composition is separated, and the separated solid body is redispersed in a mixture solution of lower alcohol and ethylene glycol.

26. The conductive nano ink composition of claim 25, further comprising a dispersant.
